(19) United States
(12) Patent Application Publication
(10) Pub. No.: US 2026/0319800 A1
(43) Pub. Date: Oct. 15, 2026

(54) Low-Compute Memory-Native Runtime Architecture Based on Structural Positioning within Memory-Defined Operational State Spaces

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/543,531

(22) Filed: Feb. 18, 2026

(51) Int. Cl. G06F 9/32; G06F 9/38

(52) U.S. Cl. CPC G06F 9/328; G06F 9/3834

(57) ABSTRACT

A memory-native runtime architecture is disclosed in which admissible computational existence and runtime manifestation arise from structural positioning within a structured memory architecture defining a memory-delimited operational state space. Structural admissibility governs runtime manifestation independently of algorithmic evaluation, decision-based processing, or iterative optimization. Evolutionary succession preserves structural lineage continuity within admissible containment relations. Reduced computational demand arises inherently from structural constraints rather than performance optimization techniques. The architecture enables implementation across embedded processors, edge devices, distributed runtime environments, and larger computational infrastructures while maintaining consistent structural behavior. Runtime manifestation occurs as a structural consequence of admissibility within the memory-defined operational state space.

### CROSS-REFERENCE TO RELATED APPLICATIONS

This application is a continuation within a family of applications directed to structurally governed runtime architectures defined through memory-native operational state spaces, admissibility boundaries, lineage-preserving structural evolution, and distributed structural positioning. Earlier applications establish constitutional runtime structures, admissibility boundary formation, reality inheritance and structural supersession, and distributed runtime environments. The present application further defines architectural consequences arising from memory-native structural admissibility, including reduced computational demand and hardware implementation characteristics resulting inherently from structural positioning within memory-defined operational state spaces.

### PRIOR ART

The following patents and published patent applications have been identified as publicly accessible references and are submitted in compliance with IDS disclosure obligations. These references relate to distributed memory architectures, disaggregated and remote memory systems, distributed shared memory, memory fabrics and pooled memory provisioning, distributed coordination engines, actor-based distributed runtime systems, tuple-space coordination models, CRDT-based synchronization techniques, distributed state management, replication frameworks, and related distributed runtime architectures known in the art as of the filing date of the present application. The inclusion of any reference herein does not constitute an admission regarding relevance to patentability.

### U.S. Patent Documents

U.S. Pat. No. 11,461,263 B2 October 2022 Malladi et al.

US 2021/0311871 A1 October 2021 Malladi et al.

US 2021/0311897 A1 October 2021 Malladi et al.

U.S. Pat. No. 11,416,431 B2 August 2022 Malladi et al.

US 2023/0020462 A1 January 2023 Malladi et al.

U.S. Pat. No. 11,841,814 B2 December 2023 Malladi et al.

US 2024/0045823 A1 February 2024 Malladi et al.

US 2025/0036590 A1 January 2025 Malladi et al.

US 2025/0004812 A1 January 2025 Radi et al.

U.S. Pat. No. 10,235,063 B2 March 2019 Frank et al.

U.S. Pat. No. 9,971,506 B2 May 2018 Frank et al.

U.S. Pat. No. 10,698,628 B2 June 2020 Frank et al.

U.S. Pat. No. 10,922,005 B2 February 2021 Frank et al.

U.S. Pat. No. 11,231,865 B2 January 2022 Frank et al.

U.S. Pat. No. 11,755,201 B2 September 2023 Frank et al.

U.S. Pat. No. 11,755,202 B2 September 2023 Frank et al.

US 2022/0398199 A1 December 2022 Calciu et al.

U.S. Pat. No. 9,262,225 B2 February 2016 Davis et al.

U.S. Pat. No. 8,484,307 B2 July 2013 Arimilli et al.

U.S. Pat. No. 10,073,809 B2 September 2018 Dinan et al.

U.S. Pat. No. 9,304,896 B2 April 2016 Chandra et al.

US 2024/0385957 A1 November 2024 Yuan et al.

U.S. Pat. No. 12,498,878 B2 December 2025 Guo et al.

U.S. Pat. No. 11,614,769 B2 March 2023 Ford

U.S. Pat. No. 8,856,593 B2 October 2014 Eckhardt et al.

U.S. Pat. No. 10,747,630 B2 August 2020 Sanakkayala et al.

U.S. Pat. No. 10,379,966 B2 August 2019 Gangadharappa et al.

U.S. Pat. No. 12,021,690 B2 June 2024 Lian et al.

U.S. Pat. No. 11,003,550 B2 May 2021 Bulkowski et al.

U.S. Pat. No. 9,459,957 B2 October 2016 Sella et al.

FOREIGN PATENT DOCUMENTS

EP 3274861 B1 March 2021 Sharma et al.

CN 115481052 B December 2025 Guo et al.

CN 115809150 A March 2023 Wang

### BACKGROUND OF THE INVENTION

Conventional computational systems typically determine runtime behavior through algorithmic execution, rule-based evaluation, optimization procedures, or inference-driven processing performed by computational units. Such approaches generally require iterative evaluation, decision-based logic, or procedural workflows that increase computational load, power consumption, latency, and architectural complexity, particularly within embedded or resource-constrained environments.

Attempts to reduce computational demand commonly rely on optimization strategies, hardware acceleration, parameter tuning, or simplified algorithmic models. However, these approaches maintain algorithm-driven runtime determination as the primary mechanism governing system operation.

Existing distributed runtime environments, memory fabrics, and shared memory architectures provide mechanisms for memory access, coordination, or data synchronization but do not redefine runtime manifestation as arising from structural admissibility within memory-defined domains.

Accordingly, there exists a need for runtime architectures in which operational determination arises inherently from structural positioning within structured memory representations defining admissible operational state spaces, enabling reduced computational demand without reliance on algorithmic optimization or procedural decision frameworks.

### SUMMARY OF THE INVENTION

The present disclosure describes a memory-native runtime architecture in which runtime manifestation arises from structural positioning within structured memory architectures defining memory-delimited operational state spaces.

A structured memory architecture establishes a structural law space defining admissible computational existence through intrinsic structural relations. Processing units maintain structural positioning relative to this structural domain. Runtime manifestation occurs when admissibility conditions inherent to the structural law space are satisfied.

Evolutionary succession preserves structural lineage continuity as structural states evolve within admissible containment relations. Structural adjudication represents constitutional admission based on structural positioning rather than algorithmic evaluation or decision-based determination.

Reduced computational demand arises inherently as a consequence of structural admissibility constraints rather than from optimization techniques. The architecture enables implementation across heterogeneous hardware environments including embedded processors, edge devices, distributed systems, and larger computational infrastructures while maintaining consistent architectural behavior.

### BRIEF DESCRIPTION OF DRAWINGS

FIG. 1—Memory-Native Runtime Determination Architecture

FIG. 2—Structural Positioning versus Algorithmic Processing Model

FIG. 3—Low-Compute Runtime Determination Flow (Structural Representation)

FIG. 4—Hardware Integration of Structured Memory Architecture

FIG. 5—Reduced Computational Pathway through Structural Positioning

### DETAILED DESCRIPTION OF THE INVENTION

The figures of this Section constitute expressive constitutional structural diagrams defining nested structural containment relations governing admissible computational existence within a memory-delimited structural law space. The illustrated relations define architectural structural positioning, admissibility boundaries, evolutionary structural continuity, structural adjudication, and runtime manifestation as constitutional structural relations only. Directional indications represent structural dependency and containment hierarchy and shall not be interpreted as execution order, algorithmic workflow, procedural progression, decision logic, optimization process, or control operation.

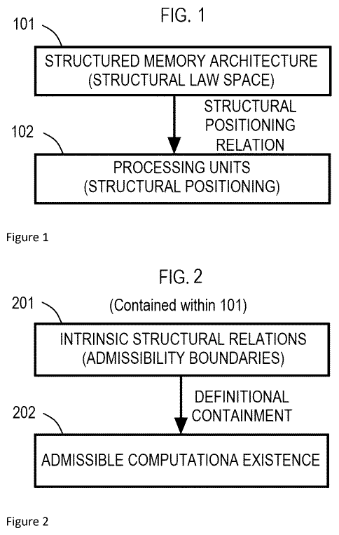

FIG. 1 illustrates a structured memory architecture (101) defining a memory-delimited structural law space serving as the constitutional root structure. The structural law space represents a bounded architectural domain within which admissible computational existence is defined through intrinsic structural relations. Processing units (102) maintain structural positioning relative to the structured memory architecture and operate as structural positioning entities. The structural law space establishes admissibility conditions defining which structural states may exist. All structural relations illustrated in FIGS. 2-5 are constitutionally contained within the structural law space defined in FIG. 1. The illustrated relation expresses nested architectural containment rather than sequential processing.

FIG. 2 illustrates intrinsic structural relations (201) defining admissibility boundaries existing within the structural law space defined in FIG. 1. Admissible computational existence (202) arises as a structural property derived from intrinsic relations rather than from evaluation, inference, or algorithmic processing. The illustrated relation expresses definitional containment within the constitutional structure and does not represent procedural filtering or operational progression.

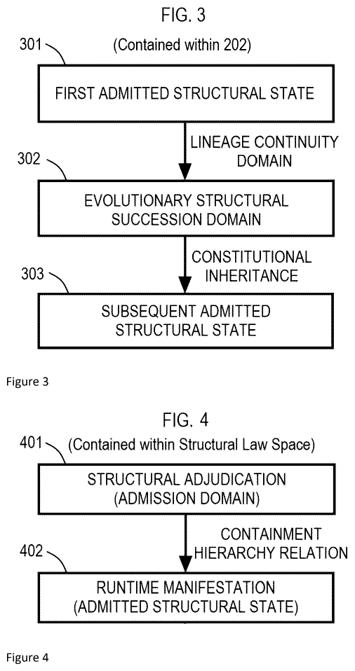

FIG. 3 illustrates evolutionary structural succession (301-303) occurring within admissible computational existence defined in FIG. 2. A first admitted structural state (301) maintains structural lineage continuity through an evolutionary succession domain (302) resulting in a subsequent admitted structural state (303). Evolutionary succession preserves structural continuity through intrinsic relations rather than through iterative computation or algorithmic transformation. The illustrated relation expresses constitutional inheritance rather than temporal progression.

FIG. 4 illustrates structural adjudication (401) operating as a constitutional admission domain within the structural law space. Runtime manifestation (402) arises when structural positioning satisfies admissibility conditions defined by the constitutional architecture. Manifestation represents structural admission rather than a computational decision or execution result. The illustrated relation expresses structural determination through containment hierarchy.

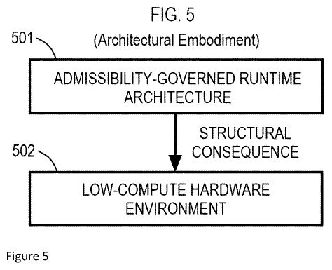

FIG. 5 illustrates a low-compute hardware environment (501-502) arising as a structural consequence of admissibility-governed runtime architecture. Reduced computational demand results from constitutional containment limiting admissible manifestation rather than from optimization or performance mechanisms. The illustrated relation expresses architectural embodiment rather than operational improvement.

This Section provides a structural architectural description aligned with the expressive constitutional structural diagrams of Section 6A. The disclosed subject matter defines a structured memory architecture establishing a memory-delimited structural law space within which admissible computational existence arises through intrinsic structural containment relations.

The described relations constitute constitutional structural positioning, admissibility boundaries, evolutionary structural succession, structural adjudication, and runtime manifestation as architectural structural relations only. The disclosed structures shall not be interpreted as procedural workflows, algorithmic execution sequences, optimization routines, decision engines, rule-based evaluation systems, or control logic.

Directional or relational descriptions express structural dependency and admissibility hierarchy rather than temporal execution order or operational sequencing.

A structured memory architecture establishes a memory-delimited structural law space defining the constitutional domain within which computational existence is admissible. Structural states arise within the law space according to intrinsic structural relations rather than algorithmic evaluation or procedural determination.

Processing units maintain structural positioning relative to the structured memory architecture. Runtime manifestation occurs when structural admissibility conditions are satisfied. Structural adjudication represents constitutional admission arising from structural containment relations rather than decision-driven computational evaluation.

Evolutionary succession preserves structural lineage continuity, whereby newly admitted structural states inherit admissible relations from prior structural states without requiring iterative computational evaluation or rule-based reasoning.

Structural admissibility defines boundaries of computational existence rather than behavioral enforcement or control. Runtime manifestation arises inherently from structural positioning within admissible containment relations defined by the structured memory architecture.

Unlike algorithm-driven systems in which runtime behavior results from evaluation, inference, or decision procedures, runtime manifestation within the disclosed architecture emerges as a structural consequence of admissibility conditions. Structural adjudication represents a constitutional boundary function ensuring that only admissible structural configurations manifest within runtime environments.

References to positioning, admissibility, or adjudication express structural relations defining existence boundaries and shall not be interpreted as logical decision rules or procedural execution mechanisms.

Reduced computational demand arises inherently from the architectural structure of admissibility rather than from optimization techniques, parameter tuning, hardware acceleration methods, or algorithmic efficiency improvements.

Because admissible structural relations define allowable runtime manifestations, processing units do not require iterative search, evaluation, or decision-driven reasoning to determine operational outcomes. Hardware computational load is structurally constrained by the memory-delimited structural law space.

The architecture therefore enables implementation within low-compute hardware environments, including embedded processors, edge devices, distributed nodes, and larger computational infrastructures, while maintaining architectural consistency independent of hardware scale.

Structural positioning refers to the relational placement of processing entities relative to admissible structural domains within the structured memory architecture. Processing units interact with structural memory representations to maintain positioning rather than to compute outcomes through procedural logic.

Memory serves as the constitutional substrate defining admissibility conditions. Runtime manifestation therefore arises through memory-native structural relations rather than through algorithmic computation or rule-based decision frameworks.

The structured memory architecture may exist across distributed environments. Multiple structural domains may coexist while preserving lineage continuity and admissibility boundaries.

Distributed processing units maintain structural positioning relative to local or federated structural domains. Runtime manifestation arises from structural coexistence rather than centralized orchestration or consensus-driven coordination mechanisms.

Structural relations described herein define constitutional admissibility conditions governing computational existence and runtime manifestation. Such structural relations shall not be interpreted as representing algorithmic evaluation processes, decision-making logic, rule-based execution systems, optimization frameworks, or inference engines.

Reduced computational demand described herein arises as an inherent architectural consequence of structural admissibility constraints rather than as an optimization result.

### Example 1: Low-Compute Embedded Irrigation Control

A structured memory architecture defines admissible structural relations representing environmental conditions and permissible system states. Sensor inputs correspond to structural positioning within admissible domains. Runtime manifestation arises through structural adjudication, enabling control behavior without iterative algorithmic evaluation. Reduced computational demand allows operation on low-power embedded processors.

### Example 2: Edge Device Environmental Monitoring

Edge devices maintain structural positioning relative to distributed structural domains defined within structured memory. Runtime manifestation arises when admissibility conditions are satisfied, enabling system response without centralized decision engines. Structural admissibility inherently constrains computational load.

### Example 3: Distributed Structural Runtime Across Nodes

Multiple nodes maintain structural positioning within a federated operational state space defined by structured memory architecture. Evolutionary succession preserves lineage continuity as structural states evolve. Runtime manifestation arises through admissible structural coexistence rather than message-driven consensus processes.

### Example 4: High-Capacity Hardware Environment

In larger computational infrastructures, the same structural architecture constrains computational demand. Even where high computational resources are available, runtime manifestation arises structurally rather than through algorithmic evaluation, maintaining architectural consistency across hardware scales.

The disclosed architecture defines admissibility boundaries as constitutional structural constraints rather than enforcement mechanisms. Any enforcement or operational policies may be externally defined without altering the structural admissibility principles described herein.

Examples provided herein illustrate structural architectural consequences and shall not be interpreted as limiting implementation scope. The architecture applies across heterogeneous hardware environments and distributed computational systems where runtime manifestation arises from structural admissibility within a memory-defined structural law space.

1. A computational system comprising:
a structured memory architecture defining a memory-delimited structural law space;
one or more processing units maintaining structural positioning relative to the structural law space;
wherein admissible computational existence is defined by intrinsic structural relations within the memory-delimited structural law space;
wherein evolutionary succession of structural states is maintained within the structural law space whereby structural lineage is preserved;
wherein runtime manifestation is admitted through structural adjudication independent of decision-based evaluation or iterative algorithmic processes; and
wherein implementation within a low-compute hardware environment results inherently from structural admissibility reducing computational demand.

2. The system of claim 1, wherein the memory-delimited structural law space defines intrinsic constraint boundaries governing admissibility.

3. The system of claim 1, wherein admissibility is independent of rule-based determination.

4. The system of claim 1, wherein evolutionary succession preserves structural lineage continuity between admitted structural states.

5. The system of claim 1, wherein structural adjudication resolves runtime manifestation without iterative optimization procedures.

6. The system of claim 1, wherein the low-compute hardware environment comprises at least one embedded processor.

7. The system of claim 1, wherein the low-compute hardware environment comprises an edge computing device.

8. A computer-implemented method comprising:
defining a memory-delimited structural law space within a structured memory architecture;
establishing admissible computational existence through intrinsic structural relations within the memory-delimited structural law space;
maintaining evolutionary succession of structural states within the structural law space whereby structural lineage continuity is preserved;
admitting runtime manifestation through structural adjudication independent of decision-based determination; and
maintaining structural positioning relative to the structural law space within a low-compute hardware environment.

9. The method of claim 8, wherein admissibility arises from intrinsic constraint boundaries of the structural law space.

10. The method of claim 8, wherein evolutionary succession occurs through admissible structural transitions defined within the structural law space.

11. The method of claim 8, wherein structural adjudication excludes rule-based decision logic.

12. The method of claim 8, wherein runtime manifestation occurs under asynchronous input conditions.

13. The method of claim 8, wherein the structured memory architecture stores structural relations defining admissibility.

14. A non-transitory computer-readable medium storing instructions that, when executed by one or more processing units, cause the processing units to:
define a memory-delimited structural law space;
establish admissible computational existence through intrinsic structural relations within the memory-delimited structural law space;
maintain evolutionary succession of structural states within the structural law space;
admit runtime manifestation through structural adjudication independent of decision-based evaluation; and
maintain structural positioning relative to the structural law space within a low-compute hardware environment.

15. The medium of claim 14, wherein admissibility is defined by intrinsic constraint boundaries.

16. The medium of claim 14, wherein structural adjudication excludes rule-based decision logic.

17. The medium of claim 14, wherein evolutionary succession maintains structural lineage.

18. The medium of claim 14, wherein runtime manifestation reduces computational demand relative to decision-based execution.

19. The medium of claim 14, wherein the structured memory architecture operates within an embedded processing environment.

20. The medium of claim 14, wherein the structured memory architecture operates within an edge computing environment.
